(19) United States
(12) Patent Application Publication
(10) Pub. No.: US 2008/0302305 A1
(43) Pub. Date: Dec. 11, 2008

(54) Interactive Animal Feeding Device

(75) Inventors: Gerald Beaudoin, St-Etienne-de-Lauzon (CA); Rene Beaudoin, St-Etienne-de-Lauzon (CA); Jacques Cimon, Ste-Foy (CA)

Correspondence Address: HOLLAND & KNIGHT LLP;ATTN: STEFAN V. STEIN/ IP DEPT., POST OFFICE BOX 1288, TAMPA, FL, 33601-1288, US

(73) Assignee: 9132-1877 Quebec Inc.

(21) Appl. No.: 11/579,623

(22) PCT Filed: May 6, 2005
(86) PCT No.: PCT/CA2005/00703

§ 371 Date: Nov. 6, 2006

(30) Foreign Application Priority Data
May 7, 2004 (CA) 2469869

(51) Int. Cl. G06F 17/00; A01K 1/10; G05B 15/02; A01K 5/02

(52) U.S. Cl. 119/51.12; 700/232; 700/240

(57) ABSTRACT

An interactive feeding device and method for animals. The device (10) includes an actuator (12) activatable by an animal, a container (18), a chute (20), a motor (14), a delivery mechanism (16) driven by the motor (14) to control passage of food from the food container (18) to the chute (20), and a controller device to operate the motor (14) subsequently to the actuator (12). The food delivery mechanism (16) preferably includes an upper (42) and lower (46) plates having upper and lower openings centered about the chute axis (48), and a disc (50) having an aperture (56) and being pivotally mounted between the plates. The aperture (56) of the disc (50) controls the passage of food from the container (18) to the chute (20) upon pivoting of the disc (50). The method includes the steps of receiving a request from an animal, providing a value of a parameter concerning the animal, retrieving a profile based on the value; and generating a command to the delivery mechanism using the profile.

### TECHNICAL FIELD

The invention relates to animal feeders, and more particularly to automatic animal feeders which involve interaction with an animal and provide a controlled quantity of food to it.

### BACKGROUND OF THE INVENTION

When animals are left alone with a large quantity of food, they tend to indulge themselves uncontrollably, which is undesirable both for health and economic reasons. Feeding devices with incorporated timers which automatically feed an animal a predetermined amount of food at a predetermined time of day are well known in the art, however, such systems do not provide for interaction with the animals.

### SUMMARY OF THE INVENTION

Accordingly, an aim of the present invention is to provide a device which is at least partially triggered by an animal to provide it with a controlled quantity of food.

In accordance with one embodiment, the invention provides an interactive feeding device for animals. The device includes an actuator adapted to generate an activation signal when activated by an animal, at least one food container, at least one food delivery member, a motor means, a food delivery mechanism driven by the motor means and adapted to control passage of food from the at least one food container to the at least one food delivery member, and a controller device adapted to receive at least the activation signal and to subsequently operate the motor means. The animal interactively requests a portion of food from the food delivery member by activating the actuator.

In accordance with one other embodiment, the invention provides an interactive feeding device for animals having a food delivery mechanism to control passage of food to the animal. The food delivery mechanism includes an upper plate member having an upper opening centered about a chute axis; a lower plate member secured to the upper plate member and having a lower opening centered about the chute axis, and a disc pivotally mounted between the upper and lower plate members about a pivot axis parallel to but separated from the chute axis by a separation distance. The disc has an aperture at least somewhat centered at a point of the disc distant from the pivot axis by the separation distance. Pivoting the disc eventually results in the aperture coinciding with the chute axis and allowing passage of food through it.

In accordance with one other embodiment, the invention provides a method of delivering a controlled quantity of food to an animal. The method includes the steps of receiving a food request from an animal, providing a value of at least one parameter concerning the animal, retrieving a profile based on the value, and generating a command to a food delivery mechanism using the profile. A controlled quantity of food is thus delivered to the animal using the profile.

In accordance with another embodiment, the invention provides an interactive feeding device and method for animals. The device (10) includes an actuator (12) activatable by an animal, a container (18), a chute (20), a motor (14), a delivery mechanism (16) driven by the motor (14) to control passage of food from the food container (18) to the chute (20), and a controller device to operate the motor (14) subsequently to the actuator (12). The food delivery mechanism (16) preferably includes an upper (42) and lower (46) plates having upper and lower openings centered about the chute axis (48), and a disc (50) having an aperture (56) and being pivotally mounted between the plates. The aperture (56) of the disc (50) controls the passage of food from the container (18) to the chute (20) upon pivoting of the disc (50). The method includes the steps of receiving a request from an animal, providing a value of a parameter concerning the animal, retrieving a profile based on the value; and generating a command to the delivery mechanism using the profile.

### BRIEF DESCRIPTION OF THE DRAWINGS

Further features and advantages of the present invention will become apparent from the following detailed description, taken in combination with the appended drawings, in which:

FIG. 1 is a front perspective view of a feeding device in accordance with an embodiment of the present invention, shown installed to an animal feeding station;

FIG. 2 is a fragmentary, side perspective view of the feeding device of FIG. 1;

FIG. 3 is a front perspective view of a mobile portion of the feeding device of FIG. 1;

FIG. 4 is a fragmentary, front perspective view, of a fixed portion of the feeding device of FIG. 1;

FIG. 5 is a perspective view of a supply tube adaptor of the feeding device of FIG. 1;

FIG. 6 is a fragmentary, rear perspective view of a fixed portion of an alternative to the feeding device of FIG. 1, including a fail-safe mechanism;

FIG. 7 is a fragmentary, side perspective view of a fixed portion of a feeding device in accordance with another embodiment of the present invention, including two food containers;

FIG. 8 is a rear perspective view of the feeding device of FIG. 7, used in combination with a weight scale and marking system.

It will be noted that throughout the appended drawings, like features are identified by like reference numerals.

### DETAILED DESCRIPTION OF THE PREFERRED EMBODIMENTS

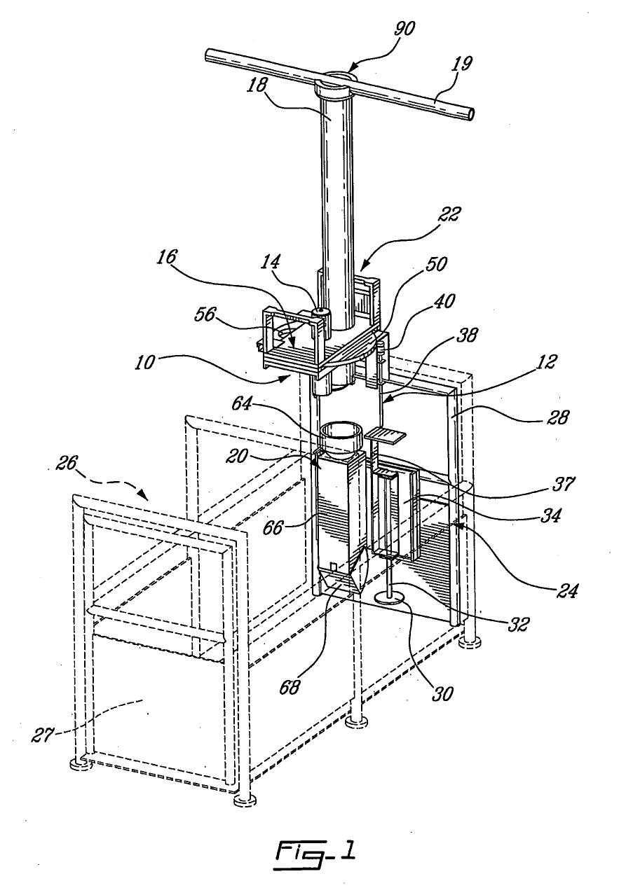

With reference to FIG. 1, an interactive feeding device 10 is shown installed to a feeding station 26. The feeding station includes two side walls, an entrance door 27 and an exit door 28 which are pivotally mounted within the frame to let the animal in and out. Part of the device 10 is a mobile food receiving portion 24 secured to the exit door 28 of the feeding station 26 in a manner to be displaced with it, whereas another part of the device 10 is a fixed food supplying portion 22 which is suspended to a supply tube 19 via an elongated food container 18.

The device 10 is provided with an actuator 12 which generates an activation signal when it is activated by an animal. The activation signal is received by a controller device (not illustrated). The controller device determines a feeding profile for the animal and operates a motor 14 according to the feeding profile to rotate a disc 50. The disc 50 has an aperture 56 in it and is part of a food delivery mechanism 16. When not operated, the disc is positioned to block food from a food container 18 to fall down into a food chute 20. However, when the aperture 56 of disc 50 passes between the food container 18 and the food chute 20 during the rotation of the disc 50, a controlled quantity of food is allowed to pass through the aperture 56 and down the food chute 20 to the animal.

The fixed food supplying portion 22 can alternatively be fixed to a frame component 29 of the feeding station 26. The mobile food receiving portion 24 is adapted to be affixed to a pivoting door 28 of the feeding station 26. It is often desirable that feeding stations 26 have both front 27 and rear doors 28, which requires that the feeding device 10 be installed partly onto one or the other of the doors 27, 28, and generally onto the exit door 28 for the animal to be positioned in the right direction to exit the feeding station. Thus, the mobile portion 24 of the device is pivoted with the door when the latter is opened and closed. The feeding device 10 may also be provided without the lower portion 24 being mobile, which simplifies it as will be discussed further down.

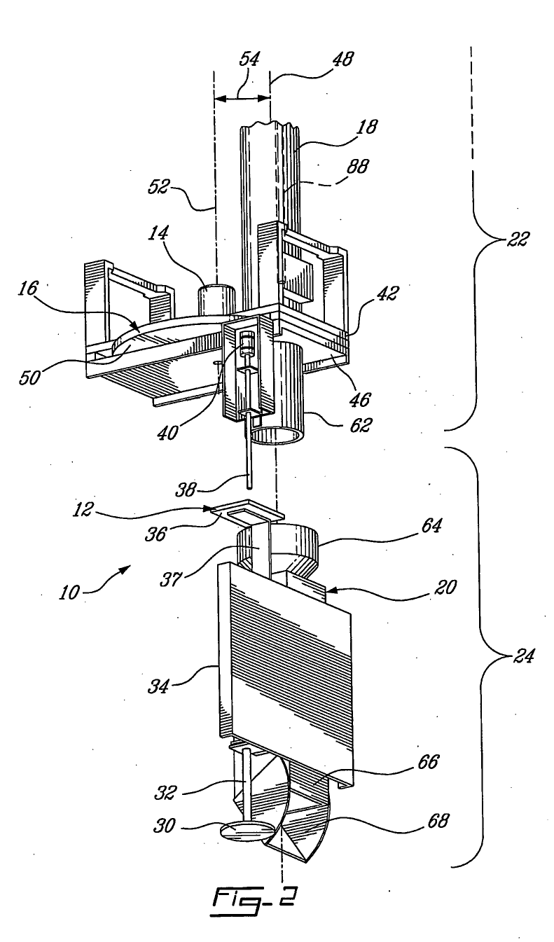

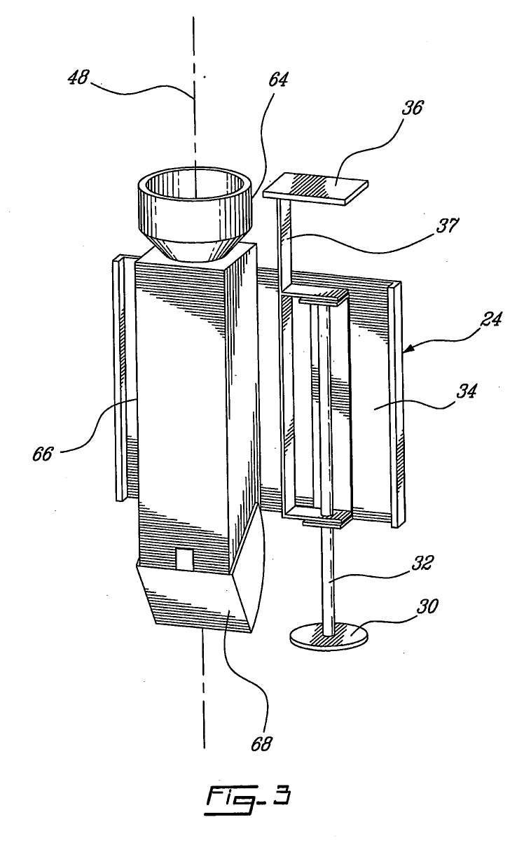

The preferred embodiment of the feeding device 10 is illustrated in more detail in FIGS. 2, 3, and 4. The actuator 12 is electromechanical, and includes a button 30 which is mounted to a lower vertical rod 32, both of which are vertically displaceable within a frame member 34. The push button 30 is meant to be contacted by an animal to cause the vertical rod 32 to be displaced vertically. A horizontal plate member 36 is fixed to the lower vertical rod 32 and abuts an upper vertical rod 38. The horizontal plate member 36 is held to the lower vertical rod 32 by a bracket 37. When the door 28 of the feeding station 26 (FIG. 1) is opened and closed, these components move from their position and back and the plate member 36 is out of alignment an realigned with upper vertical rod 38. The width of the horizontal plate member 36 provides tolerance to imperfect aligning of rod 38 following movement of the door 28. When an animal pushes button 30 upwardly, the horizontal plate member 36 is pushed upwardly by the assembly (30, 32, 37), and pushes the lower end of upper vertical rod 38. The upper vertical rod is vertically displaceable within the fixed portion 22 and is thus displaced by the movement of horizontal plate 36. The upper end of upper vertical rod 38 is aligned with a sensor 40 and penetrates it when the rod 38 is pushed up. This results in the upper end thereof being detected within the sensor 40 and activates the activation signal as a result of an animal contacting the button 30. The entire actuator 12 can be provided in a single, non-separable component instead of in the fixed and mobile components described above. Further, instead of being mechanical, the actuator can also be made wireless and transmit the signal from a sensor provided as part of the mobile portion to the controller device via a receiver provided as part of the fixed portion. Further still, the signal can be transmitted via a wire disposed near the pivot axis of the door.

The preferred controller device is a computer, and if a plurality of feeding devices 10 are used, like in a farm for example, they are preferably commonly connected to a single central computer via network connections. Computers are adapted to process data coming from over two hundred feeding devices 10. In alternative applications, the controller device is provided as simpler electronics and individual controllers are used for individual devices. The time and date of the request, the quantity of food requested, and values of other parameters concerning the animal which will be discussed further on can be stored in the computer to create a database of information on the animal which can be used for studies.

Preferably, the computer will retrieve a profile of the animal from the database using the value it receives, and determine how much food is to be fed to the animal using the profile. For example, if the animal successively requests food by activating button 30 twice in a row in a limited period of time, the computer checks the feeding history and compares the value of the “number of feeds within the predetermined period” parameter and consequently selects a smaller quantity of food, or simply refuses to provide food, when it determines there has not been enough time elapsed between the two requests. Values for other parameters will be discussed further down.

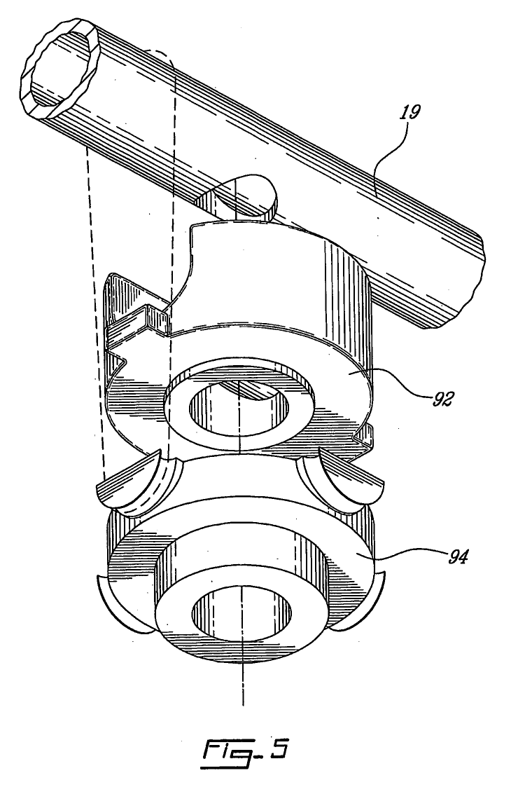

The animal food is stored in an elongated food container 18 of generally cylindrical shape. Food container 18 has an upper inlet opening and a lower outlet opening. The entire upper fixed portion 22 is suspended from a supply tube 19 by means of an orientable adaptor 90 (FIG. 1). The orientable adaptor 90 is more clearly depicted in FIG. 5 and will be detailed later. Food is provided to the container 18 from the supply tube 19 through the orientable adaptor 90.

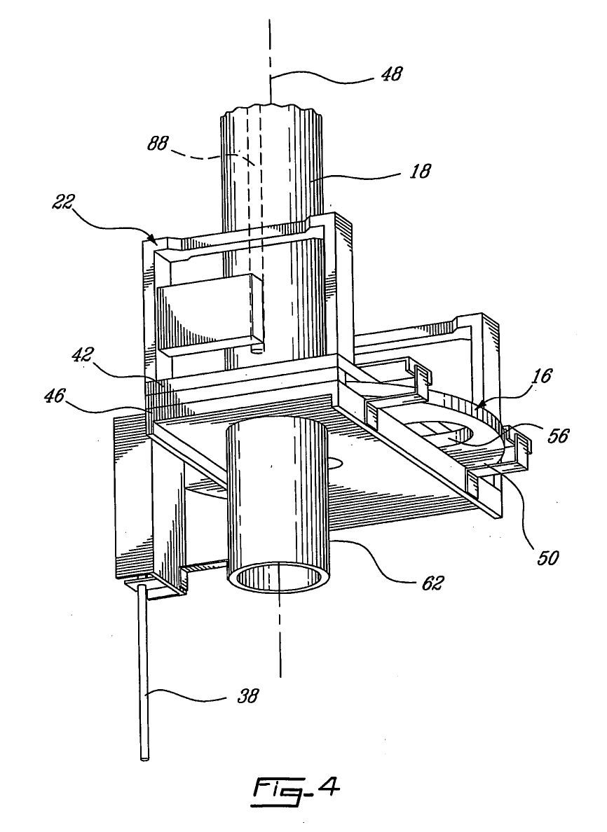

The controlled quantity of food is dispensed from the food container 18 by means of a disc 50 with an aperture 56 therein being rotatable about an axis allowing the aperture 56 to be vertically aligned with the outlet of the food container 18. This alignment of aperture 56 allows food to escape the container 18 by the action of gravity. For increased structural resistance and practicality, the disc 50 is provided between two parallel plates 42, 46, (FIGS. 2 and 4) both of which also have an opening therein aligned with the outlet of the food container 18. The food container 18, is preferably vertically oriented. Its lower end has a circular outlet opening (not shown) of the same size as the openings defined in the parallel plates 42, 46, and is secured to the perpendicularly disposed upper plate 42. A hollow neck member 62 also defining an opening corresponding to the opening in the plates 42, 46, is provided in the shape of a tube with its upper circular opening secured in a communicating fashion with the opening (not shown) of the perpendicular lower plate member 46. Thus, the openings of the vertical container 18, the two plate members 42, 46, and the neck 62 communicate along an axis which will be referred to herein as the chute axis 48. And the angular position of the aperture 56 in the disc 50 controls this communication.

The disc 50 is rotatably mounted between the two plate members 42, 46 about an axis perpendicular to the plate members 42, 46, and keeps the food from the vertical container 18, to pass to the neck 62 and to fall down the food chute 20 unless its aperture 56 is aligned with the chute axis 48. The axis about which the disc 50 is rotatably mounted is referred to as the disc axis 52. The disc axis 52 is parallel to and spaced apart from the chute axis 48 by a distance referred to as the separation distance 54. The radius of disc 50 is greater than the axis separation distance 54, and the disc 50 radially extends to cover the outlet opening of vertical container 18 completely. The aperture 56 in disc 50 is preferably obround, radially oriented, and is centered on a point of the disc 50 at a radial distance equivalent to the separation distance 54, for the aperture 56 to allow passage of food from the vertical container 18 to the neck 62 when it is pivoted into alignment with the chute axis 48. The disc 50 is pivoted by the action of an electric motor 14.

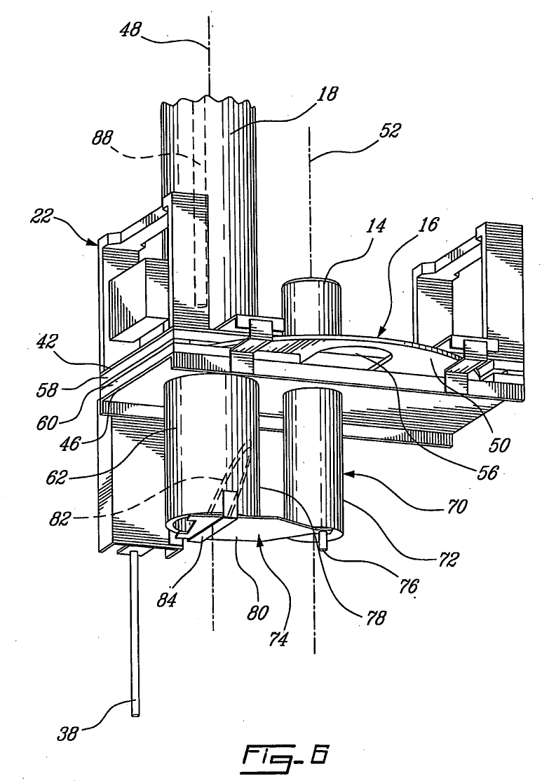

Though the disc 50 can be provided in thicker plastic, as shown in FIGS. 1, 2, 4 and 7, the disc is preferably provided as a thin sheet of metal, as illustrated in FIG. 6. It is approximately 0.15875 cm thick and is provided between layers 58, 60 of a plastic material disposed on either side of the disc 50 to reduce friction with the plates 42, 46. Layers 58, 60 can either be secured to the disc, or to the plates 42, 46, and can be provided in a material having a low friction coefficient with the material of the disc 50 or plates 42, 46, respectively.

Henceforth, to provide food to the animal, the controlling device determines a quantity of food to be dispensed, and activates the disc 50 via the electric motor 14. Preferably, the controlling device associates the quantity of food to be dispensed to a number of complete 360° rotations of the disc. At each rotation, the aperture 56 passes once across the chute axis 48 for a limited period of time and causes a quantity of food referred to herein as a “food unit” to drop from container 18, through aperture 56, and down the neck 62 towards the food chute assembly 20 and the animal. The sum of food units dropped down totalizes the amount of food determined to be dispensed. The amount of food in each food unit is predetermined, and depends of rotational speed of the disc 50 and the size of the aperture 56. Alternatively to having one aperture, the disc can be provided with two apertures as illustrated in FIG. 1, or more.

Greater control of the electric motor by the controller device can also be provided. For example, the controller device can vary the amount of time the aperture 56 stays in place along the chute axis 48, or be adapted to activate the disc in both clockwise and counter-clockwise directions. Further, in alternative embodiments, a screw conveyor (not shown) activated by the electric motor 14 and disposed in a manner to bring the food from the food container 18 to the food chute 20 can be used instead of the disc-based food delivery mechanism 16. Other types of conveyor systems provide additional alternatives.

Like the activator 12, the food chute 20, is also preferably composed of a fixed portion (62) and a mobile portion (64, 66, 68) to accommodate the pivotal movement of the door 28 (FIG. 1). The fixed portion includes the neck 62, whereas the mobile portion includes a funnel 64, a tube 66, and a directional spout 68. The funnel 64 is preferably made wider than neck 62 to compensate for the potential imprecision in alignment between the fixed 22 and mobile 24 portions resulting from imprecise positioning of the door 28, as it was previously discussed with reference to the activator 12. As shown, the tube 66 is preferably of rectangular cross-section, and the directional spout 68 can be oriented in any of four orientations as needed by removing and reinstalling it in another direction. This desired directional variability of the spout is optional and can alternatively be provided by using a tube 66 of circular cross-section with a pivotally mounted spout. Inclination of the spout is also preferably adaptable by pivoting the spout about a transversal axis to the tube, as shown. In applications of the invention that allow use of the feeding device 10 without a mobile component, the food chute 20 is preferably provided as an extension 76 of neck 62, without the funnel 64.

Although the fixed portion 22 (FIG. 1) can be secured to a frame portion of the feeding station, or to another frame component, it is preferably suspended from the supply tube 19. A hole is defined within the supply tube towards the container 18, and an adaptor 90 ensures the communication of food between the supply tube 19 and the food container 18. The preferred adaptor is depicted in FIG. 5 and is orientable to receive a supply tube in any one of two perpendicular directions. In fact, the supply tubes in barns are sometimes aligned with the feeding station, and other times perpendicular to them. The orientable adaptor is composed of two portions, a tube portion 92 and a container portion 94. The tube portion 92 has a groove defined within its upper face to receive the supply tube. Its lower face has a male mating member. The tube portion 92 also has two stubs, one stub extending from each opposite side in the orientation of the groove. The upper face of the stub is made to correspond to the bottom of the groove, whereas the lower face of the stubs are made to correspond to the lower face of the tube portion 92. The container portion 94 has a female mating member at its upper face, to mate with the male mating member of the tube portion 92. The container portion 94 is adapted to receive the container 18 at its lower face. The container portion 94 has four stubs extending from its side at 90 degree angles. A hole traverses both the container portion 94 and the tube portion 92 which communicates between the two when the latter are assembled. To adapt to two perpendicular directions of supply tubes, the tube portion stubs are positioned in alignment with two selected stubs of the container portion 94. The adaptor 90 is then secured to the supply tube 19 by U shaped fasteners joining the selected container portion stubs to the supply tube. The tube portion stubs act as spacer between the selected container portion stubs and the supply tube 19. Food is thus transferred from the supply tube 19 to the container 18 by passing through the communicating holes in the container portion 94 and tube portion 92.

As shown in FIG. 6, a fail-safe system 70 is used with the device to overcome a potential problem which will now be explained. If the device 10 fails, as in the case of a power failure or a mechanical problem, with the aperture 56 in line with the chute axis 48, the food container 18 will continuously empty itself into the chute 20 until the failure is corrected, since there is nothing to stop it. In this particular situation, the quantity of food is no longer controlled. This is a exceptional situation, but is nevertheless problematic, especially in a farm where over one hundred devices 10 may be on the same power circuit. To overcome this, the device is preferably provided with the fail-safe system 70.

The fail-safe system 70 includes a shaft 72 which coincides with the disc axis 52 and is assembled to the disc 50 in a manner to turn with it. At the end of the shaft 72 there is an extension 76, which is off-centered relative to the axis of the shaft in the radial direction of the aperture 56, and to which a stopper plate 74 is pivotally mounted. The stopper plate 74 has a blocking end 80 and a pivot end 78. The pivot end 78 is pivotally mounted under the extension 76. The blocking end 80 is fitted between the lower opening of neck 62, and a bracket 84 which is secured to the neck 62. The blocking end 80 is thus free to slide transversally between the neck 62 and bracket 84, but is held by the bracket 84 in the vertical direction. The shaft 72 can alternatively be a C-shaped folded metal sheet.

The extension 76 is oriented in the same radial direction as the aperture 56 with respect to the disc axis 52. When the disc 50 is rotated until the aperture 56 and extension 76 are oriented toward chute axis 48, aperture 56 opens the passage for food from container 18 to fall down to neck 62, whereas blocking end 80 is translated by the rotating movement of the extension 76 and is positioned so as to block the exit at the lower opening of the neck 62. The food falling through aperture 56 is thus held within the neck 62 and a maximal volume of food corresponding to the volume of the neck 62 is allowed therein. When the disc 50 if pivoted further and the aperture and extension 76 point in a direction opposite to the chute axis, the blocking end 80 of the stopper plate 74 is pulled back by the rotation of extension 76 and allows food to exit the neck 62. However, the food can no longer enter the neck 62 since the disc 50 blocks the outlet from the container 18. Hence, food is either blocked at the entrance or at the exit to neck 62 and the maximal amount of food that can reach the animal is limited to the volume of neck 62 in the advent of a system failure. Indeed, the rotational movement of the shaft 72 is transformed to a somewhat translational movement of the stopper plate 74, in a manner similar to a crankshaft and piston known to car engines. The blocking end 80 of stopper plate 74 is provided of a size sufficient to block the exit of neck 62 completely, and a guiding plate 82 is preferably provided inside neck 62 to keep food from accumulating inside neck 62 unnecessarily.

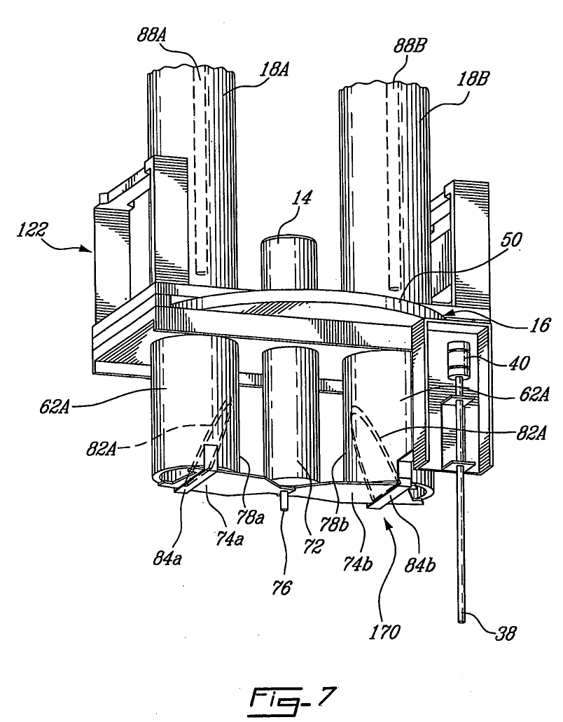

In FIG. 7, an alternative embodiment to the feeding device 10 is depicted where two vertically disposed food containers 18A and 18B are used. As it will now be discussed, the advantage of providing two food containers 18A and 18B with an appropriate food delivery mechanism 16 is that different types of feed can thus be provided to the animal depending of a value of a parameter concerning the animal. For example, if the controller device knows the value of the “weight” parameter for the animal, it can determine a different food appropriate for the profile of that particular animal. The profile can also concern the age of the animal, the value of which can be accessed in the database by the computer. In alternative applications, more than two containers are used.

A fuller variety of food is obtained by varying the ratio of each of both types of food in the final mix. For each food container 18A, 18B, the same food mechanism 16 can be used, although its control is different, as discussed further. Preferably, only one disc 50 serves for both food containers, and each container has a corresponding neck 62. Although the electric motor 14 is the same, it is preferable to provide a more complete control of the disc 50 by the controller device when mixing different percentages of the two types of feed. For example, to obtain a 40%-60% mixture, the controller device, or a separate controller, commands the disc 50 to make two complete rotations, which provides, say, 80% of the final mixture. Then, the controller device commands a half a turn in the direction of the feed of which 60% is desired, and thus provides the final 20% in the mix. Alternatives to this command system include varying the angular speed of rotation of the disc 50 depending on which container the aperture is letting the food out of, and stopping the rotation of the disc 50 for a determined period of time to allow more food to come out of the desired one of the two containers 18A, 18B.

To obtain a precise measure of the quantity of food being dispensed, sensors 88A, 88B are used in the food containers 18A, 18B, in any suitable embodiment. The sensors 88A, 88B are preferably connected to the controller device. Use of sensors is recommended in applications where the precision of the quantity of food measurement is important.

A fail-safe system 170 adapted for two containers 18A, 18B is illustrated in FIG. 7. Two stopper plates 74A and 74B are provided, which are both pivotally connected about the same axis under the extension 76. When one blocking end 80 is pulled away from the corresponding neck 62, the other is pushed to block the corresponding neck 62. Hence, the blocking end 80 above which the aperture is letting food pass through to the neck 62 is automatically positioned to block the exit to the neck 62.

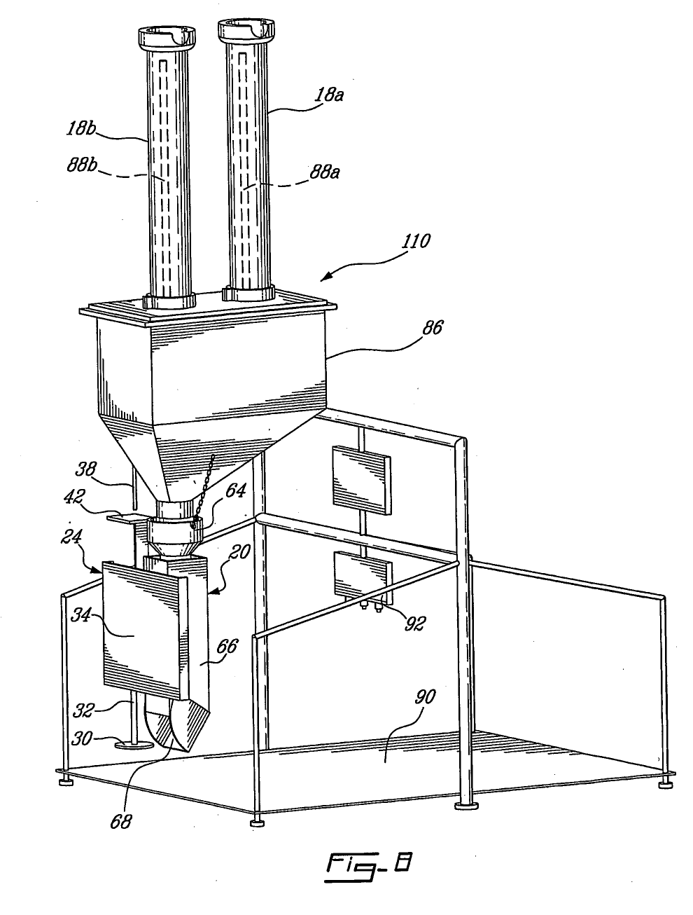

For channeling the food to the animal after it passes through the aperture 56, either an individual chute is used for each food container, or a funnel box 86 is used, as shown in FIG. 8, whereby the food coming out from either food container passes into the box 86, and is funneled down a single chute 20. Preferably the funnel 64 is provided as en extension to a tube, the tube being inserted within the chute 66. When the door is opened and subsequently closed, the funnel can thus be pulled upwardly by an operator to bring it closer to the spout of the funnel box 86 or to the neck 62. It is then fastened into position, preferably suspended from the funnel box 86 or the neck 62 by a chain. The movement of the funnel 64 is limited to linear movement by the tube of the funnel 64 being guided within the chute member 66.

The feeding device of the present invention can be used for a single animal or for a group of animals. When using the device with a single animal, there is no confusion as to which particular animal is requesting food by activating the activator. However, when using a single device with a plurality of animals and it is desired to offer a somewhat personalized treatment for each animal, it is advantageous to use a collar on the animal which is coded with a unique identification signal. A decoder provided as part of the feeding station can then receive a signal from the collar and identify the animal. The controller device, preferably a computer, can then access a database and determine a feeding profile corresponding to the animal. For example, animals below a certain age can be associated to the junior profile and be served a corresponding quantity of food whereas animals passed that age can be associated to a different profile and be fed a correspondingly different quantity of food.

When the identity of the animal is know, it is possible to create a database by saving specific information about the animal in the computer. For example, the computer can record a feeding history and the weight evolution of the animal. Thus, when food is solicited by the animal, the computer receives the activation signal and accesses the database and determines how much food the animal should receive depending on its particular eating habits or on the amount of food it has received on that particular day. Preferably, the database can be accessed wirelessly from a remote location by a user via a portable computer interface.

In some applications, it is not essential to know the exact identity of the animal. For example, it may be desired to feed the animal depending on its weight only. In this case, a weight scale is provided directly as the floor of the feeding station and the animal is automatically weighed when it boards the feeding station. The information of the weight of the animal is fed to the computer which selects a corresponding weight profile to the weight recorded. The evolution of the weight of the animal can be recorded in the database and the computer can compare the weight detected to a standard evolution curve to determine how much food is to be fed to the animal. Depending on the weight profile selected, the animal is fed a different quantity of food.

In one alternative, the scale serves as the sole actuator, and the simple action of the animal entering the feeding station and standing on the scale 24 is sufficient for the activation signal to be sent to the controller device. This embodiment avoids the use of the button 30. In an other alternative, the scale 24 serves as part of the actuator, in combination with the button 30, which are both activated for the activation signal to be transmitted.

A marking device 92 is advantageously used when it is desired to mark the animals depending on at least one parameter value detected by the detection system. One example of such an embodiment is provided with the scale acting as a detection system for detecting a value of a weight category parameter. For example, animals with a weight over a predetermined value are identified as being part of weight category “A”, whereas those under that predetermined value are identified as being part of weight category “B”. The value signal from the detection system (in this case, the scale) is then sent, optionally via the controller device, to the marking device 92 that marks the animal accordingly. Marking devices are known in the art and any marking device suitable for the application can be selected. Alternatively, the detection device is the collar and decoder discussed above, and the marking is done following the recognition of the animal identity by the decoder to indicate, for example, that the animal is ready to be sent to the slaughterhouse.

The method of feeding a controlled quantity of food to an animal in accordance with an embodiment of the invention comprises the main steps of receiving a request from an animal, providing a value of a parameter concerning the animal, retrieving a profile for the animal using the value, and generating a command to a food delivery mechanism using the profile. The request is generated by an animal either boarding a scale provided as the floor of the feeding station or activating an activator button. The request is then received by the controller device. The parameter is the weight or the identification of the animal and a profile is retrieved using the value provided.

In the case of weight, the weight profile (e.g. young or mature) is recovered and the animal is fed accordingly. The animal can also be marked accordingly by an appropriate marking device. One example of this is to provide a weight value of the animal by the scale, to retrieve the animal profile by comparing the animal weight to a predetermined growth curve, and to mark the animal for the slaughterhouse if it is determined that animal will not grow sufficiently by comparison to the normal growth curve.

In the case of identification, the identity of the animal can be retrieved by decoding a unique code emitted by a medal provided on the animal. The identity can also be retrieved automatically when only one animal uses the device. With the identity of the animal known, a feeding history profile or a desired weight profile can be retrieved and the animal be fed or marked accordingly.

To generate the command to the food delivery mechanism, a quantity of food to feed the animal is determined, using the profile, and the command generated depends on the quantity of food determined. The food is fed through an aperture in a disc of the food delivery mechanism, the disc is pivoted for a number of revolutions thus letting a quantity of food pass through the aperture for each revolution, the quantity of revolutions corresponds to the quantity of food determined.

The method also preferably includes storing a value of quantity of food fed to the animal provided by the sensors, as well as the time and date of the delivery of food into a food history database. The food history database can thereafter be accessed by a user to check on the particular animal, or by the computer to create a personalized feeding profile concerning the animal.

The device of the invention is preferably used for feeding pigs.

The embodiments of the invention described above are intended to be exemplary only. The scope of the invention is therefore intended to be limited solely by the scope of the appended claims.

1. An interactive feeding device for animals, the device comprising: an actuator adapted to generate an activation signal when activated by an animal;
at least one food container;
at least one food delivery member;
a motor means;
a food delivery mechanism driven by the motor means and adapted to control passage of food from the at least one food container to the at least one food delivery member; and
a controller device adapted to receive at least the activation signal and to subsequently operate the motor means;
whereby an animal interactively requests a portion of food from said food delivery member by activating the actuator.

2. The interactive feeding device of claim 1 wherein the food delivery member includes a food chute, the at least one food container has an opening located on a chute axis, and the food delivery mechanism comprises a disc pivotally mounted on a disc axis parallel to but spaced apart from the chute axis by a separation distance, the disc having an aperture at a radial distance from the disc axis being equivalent to said separation distance, whereby pivoting of the disc by the motor means eventually results in said aperture being aligned with said chute axis and allowing a controlled quantity of food to pass through it and down said food chute.

3. The interactive feeding device of claim 2 further comprising a hollow cylindrical neck member being centered about the chute axis and having an inlet and outlet openings, the neck member being on a side of the disc opposite to the container, with the inlet facing the disc; a shaft parallel to the neck and centered about the pivot axis, the shaft having an off-centered extension oriented in the radial direction of the aperture at one joint end thereof, and being secured to the disc at its other end; and a blocking plate having a blocking end translatably held against the outlet of the neck and a joint end secured to the off-centered extension of the shaft; whereby the blocking plate blocks the outlet of the neck when the aperture coincides with the chute axis to limit the passage of food through the neck in the advent of system failure.

4. The interactive feeding device of any one of claims 2 and 3 wherein the controller device controls the quantity of food supplied to the animal by operating the motor means to pivot the disc for a number of complete revolutions, with one unit of food corresponding to a predetermined quantity thereof passing through the aperture during each complete revolution.

5. The interactive feeding device of any one of claims 1 to 4 wherein the actuator comprises a button activatable by an animal to activate the actuator.

6. The interactive feeding device of claim 5 wherein said activator and said food delivery member comprise a lower mobile portion adapted to be received onto a door of a feeding station, and a fixed portion adapted to be received onto a fixed component relative to the feeding station, wherein the button and a spout of the food delivery member are part of the mobile portion, and wherein at least one of:
transmission of the button activation to the fixed portion is done by at least one of mechanical, electrical and wireless connection; and
passage of said food to said spout is done by said food falling from one of the at least one food container into a funnel being part of the mobile portion and connected to the spout.

7. The interactive feeding device of any one of claims 1 to 6 wherein the food container has an inlet connected to a supply tube via an adaptor, the adaptor comprising: a tube portion for receiving the supply tube and having a lateral tube portion stub extending transversally from opposite sides in the orientation of the tube; a container portion for receiving the food container and the tube portion on opposed faces, and having four container portion stubs extending at 90 degree angles from one another; whereby the adaptor can receive a supply tube in two orthogonal directions by aligning the tube portion stubs with the corresponding two container portion stubs and by securing the two corresponding container portion stubs to the supply tube.

8. The interactive feeding device of any one of claims 1 to 7 further comprising at least one detection device for detecting a value of at least one parameter relating to an animal proximal to the device and for generating at least one parameter value signal corresponding to the value detected.

9. The interactive feeding device of claim 8 comprising two food containers, each one for containing a different food, and wherein the food delivery mechanism is adapted to control passage of food from either one of the two food containers to the at least one food delivery member, and wherein the controller device further receives the parameter value signal and operates the electric motor to drive the food delivery mechanism to control said passage of food accordingly to said parameter value signal received.

10. The interactive feeding device of claim 9 wherein each two food container has an opening located about a corresponding container opening axis each parallel to the other, and the food delivery mechanism comprises a disc pivotally mounted on a disc axis parallel to and between the container opening axes, the disc having at least one aperture adapted to be aligned with either opening by pivoting the disc about its axis to allow a controlled quantity of food to pass therethrough and down said at least one food delivery member.

11. The interactive feeding device of claim any one of claims 8 to 10 wherein the detection device is a weight scale provided as a floor of the feeding station, the scale detecting a value of an animal weight parameter, whereby the scale automatically weighs the animal when it comes onto the floor of the feeding station.

12. The interactive feeding device of claim 11 wherein the scale is the actuator.

13. The interactive feeding device of any one of claims 8 to 12 further comprising a marking device adapted to receive the parameter value signal and to be activated to mark the animal differently depending on the parameter value received.

14. An interactive feeding device for animals having a food delivery mechanism to control passage of food to the animal, the food delivery mechanism comprising:
an upper plate member having an upper opening centered about a chute axis;
a lower plate member secured to said upper plate member and having a lower opening centered about the chute axis; and
a disc pivotally mounted between the upper and lower plate members about a pivot axis parallel to but separated from the chute axis by a separation distance, the disc having an aperture at least somewhat centered at a point of said disc distant from the pivot axis by the separation distance;
whereby pivoting the disc eventually results in the aperture coinciding with the chute axis and allowing passage of food through it.

15. The interactive feeding device of claim 14 further comprising an upper and lower friction reducing plate members between said disc and said upper plate member, and said disc and said lower plate members, respectively, whereby the friction reducing plate members reduce friction of said disc during said pivoting.

16. The interactive feeding device of any one of claims 14 to 15 further comprising a hollow cylindrical neck member having an inlet and outlet openings, the inlet being secured to the lower plate member and centered about the chute axis; a shaft parallel to the neck and centered about the pivot axis, the shaft having an off-centered extension oriented in the radial direction of the aperture at one joint end, and being secured to the disc through the lower plate at the other end; and a blocking plate having a blocking end translatably held against the outlet of the neck and a joint end secured to the off-centered extension of the shaft; whereby the blocking plate blocks the outlet of the neck when the aperture coincides with the chute axis to limiting the passage of food through the neck in the advent of system failure.

17. A method of delivering a controlled quantity of food to an animal comprising the steps of:
receiving a food request from an animal;
providing a value of at least one parameter concerning the animal;
retrieving a profile based on said value; and
generating a command to a food delivery mechanism using said profile;
whereby a controlled quantity of food based on said profile is delivered to the animal.

18. The method of claim 17 wherein the step of receiving a request includes at least one of the animal boarding a weight scale in a feeding station, and the animal activating an activator button.

19. The method of any one of claims 17 to 18 wherein the parameter is one of the weight value of the animal and an identification value of the animal.

20. The method of claim 19 wherein the parameter is a weight value of the animal and wherein retrieving a profile includes retrieving a weight range using the value.

21. The method of claim 19 wherein the parameter is an identification value and the step of providing a value includes detecting a unique identification code provided from a collar worn by said animal.

22. The method of claim any one of claims 19 and 21 wherein the parameter is an identification value, and wherein said step of retrieving a profile comprises retrieving a feeding history profile of said animal using the identification value received.

23. The method of any one of claims 17 to 22 further comprising the step of marking the animal using the profile retrieved.

24. The method of any one of claims 17 to 23 wherein the step of generating a command comprises determining a quantity of food to be given to said animal using said profile, and activating the food delivery mechanism to provide said quantity to said animal.

25. The method of any one of claims 17 to 24 wherein the food delivery mechanism includes a disc having an aperture to let food pass through, further comprising the step of pivoting the disc for a number of revolutions thus letting a quantity of food pass through the aperture for each revolution, the quantity of revolutions being related to the quantity of food determined.

26. The method of any one of claims 17 to 25 further comprising the step of storing the value of at least one of the quantity of food delivered and the time and date of food delivery in a feeding history database.
